(19) United States
(12) Patent Application Publication
(10) Pub. No.: US 2020/0214310 A1
(43) Pub. Date: Jul. 9, 2020

(54) CREAMERS WITH IMPROVED TEXTURE/MOUTHFEEL AND METHOD OF MAKING THEREOF

(71) Applicant: SOCIETE DES PRODUITS NESTLE S.A., Vevey (CH)

(72) Inventors: Jun-Tse Ray Fu, Dublin, OH (US); Alexander A. Sher, Dublin, OH (US)

(21) Appl. No.: 16/624,372

(22) PCT Filed: Jun. 20, 2018
(86) PCT No.: PCT/EP2018/066324

§ 371 Date: Dec. 19, 2019

Related U.S. Application Data
(60) Provisional application No. 62/527,136, filed on Jun. 30, 2017.

(51) Int. Cl. A23C 11/04; A23C 11/08; A23L 9/20; A23F 5/24

(52) U.S. Cl. CPC A23C 11/04; A23C 11/08; A23V 2002/00; A23F 5/24; A23L 9/22

(57) ABSTRACT

The present invention relates to beverage products, in particular a liquid non-dairy creamer composition having a texture similar to a sweetened condensed milk or yogurt-like. The composition comprises oil in the range of 10-16 wt/wt %; caseinate salts in the range of 1.5 to 2.2 wt/wt %; mono-/diglycerides in the range of 0.13 to 0.3 wt/wt %; tartaric acid esters of monoglycerides in the range of 0.4 to 0.8 wt/wt %; kappa-carrageenan in the range of 0.06 to 0.09 wt/wt %; iota-carrageenan in the range of 0.05 to 0.11 wt/wt %; and guar gum in the range of 0.1 to 0.4 wt/wt %.

### FIELD OF THE INVENTION

The present invention relates to coffee creamers and the method to produce the same. More specifically, the present disclosure is directed to creamers with improved texture/mouthfeel.

### BACKGROUND OF THE INVENTION

Creamers are widely used as whitening agents with hot and cold beverages such as, for example, coffee, cocoa, tea, etc. They are commonly used in place of milk and/or dairy cream. Creamers may come in a variety of different flavours and provide mouthfeel, body, and a smoother texture. Creamers can be in liquid or powder forms. A liquid creamer may be intended for storage at ambient temperatures or under refrigeration, and should be stable during storage without phase separation, creaming, gelation and sedimentation. The creamer should also retain a constant viscosity over time. When added to cold or hot beverages such a coffee or tea, the creamer should dissolve rapidly, provide a good whitening capacity, and remain stable with no feathering and/or sedimentation while providing a superior taste and mouthfeel. Mouthfeel also denoted richness, texture or creaminess, is usually provided by the oil emulsion present in the creamer.

This, it is critical not only enhance texture/mouthfeel of coffee with creamers but also have stable liquid coffee creamers as is without compromising creamer stability over shelf life (at least 6 months at refrigeration and ambient temperatures for aseptic products).

All previous attempts to increase texture/mouthfeel of liquid creamers had the following drawbacks:

High viscosity of liquid creamers resulted in poor pour-ability from the bottle

Dripping-back liquid stream during pouring

Phase separation (gelation, serum formation) during shelf life

The present invention relates to stabilizing systems and composition of non-dairy shelf-stable aseptically packaged liquid creamers, and to the process of making thereof.

### SUMMARY OF THE INVENTION

The present invention now solves the foregoing problems by providing a stable beverage composition having enhanced or improved organoleptic properties.

In one embodiment, the creamer of the present invention is Extended Shelf-Life (ESL) liquid creamers with yogurt-like texture or sweetened condensed milk-like texture, formed by the interaction of oil(s), protein(s), carbohydrate(s), and optionally sweetener(s), flavor(s), and stabilized by the use of complex systems containing the combinations of hydrocolloid(s) and emulsifier(s).

In another embodiment, the creamer of the present invention is aseptic shelf-stable liquid creamers with yogurt-like texture or sweetened condensed milk-like texture, formed by the interaction of oil(s), protein(s), carbohydrate(s), and optionally sweetener(s), flavor(s), and stabilized by the use of complex systems containing the combinations of hydrocolloid(s) and emulsifier(s).

In a first aspect, the invention relates to a composition comprising oil in the range of 10-16 wt/wt %; caseinate salts in the range of 1.5 to 2.2 wt/wt %; mono-/diglycerides in the range of 0.13 to 0.3 wt/wt %; tartaric acid esters of monoglycerides in the range of 0.4 to 0.8 wt/wt %; kappa-carrageenan in the range of 0.06 to 0.09 wt/wt %; iota-carrageenan in the range of 0.05 to 0.11 wt/wt %; and guar gum in the range of 0.1 to 0.4 wt/wt %.

In one aspect, the present invention relates to a creamer with yogurt-like texture comprising calcium lactate in the range of 0.1 to 0.3 wt/wt %.

In one embodiment the aseptic creamers are shelf-stable at 20° C. for at least 6 months, 3 months at 30° C., and 1 month at 38° C.

The creamers are easily dispersible in coffee, stable in hot and cold acidic environment, without feathering, breaking emulsion, de-oiling, flocculation and sedimentation. When added to coffee or tea or other liquid products, the creamers provide improved mouthfeel, full body, smooth texture, and also a good flavor with no off-flavor notes developed during storage time.

Though the present invention discloses the coffee creamers, use of the creamers, it is not limited for only coffee applications. For example, the creamers can be also used for other beverages, such as tea or cocoa, or used with cereals or berries, creamers for soups, in many cooking applications, etc.

The products of the invention present excellent organoleptic properties, in particular in terms of texture and mouthfeel even when very low levels of fat are used. Besides, the products of the invention show good stability during the product shelf-life.

Another aspect of the present invention relates to a process of preparing the creamer comprising: (i) dissolving the ingredients as defined above except oil in hot water under high shear mixing; (ii) adding oil to the mixture of step (i) under high shear mixing; (iii) homogenizing the composition at temperature ranging from 70-85° C.; (iv) sterilizing the composition using ultra-high temperature (UHT) treatment at 138-147° C.; (v) homogenizing the composition at temperature ranging from 70-85° C.; and (vi) cooling and filing the creamer under aseptic conditions.

### DETAILED DESCRIPTION OF THE INVENTION

In the following description, the % values are in wt by wt % unless otherwise specified.

Advantageously and unexpectedly, a unique combination of the hydrocolloid texturizing/stabilizing system ingredients was found that improves beverage texture/mouthfeel and provides a pleasant, smooth creamy taste when the creamers added to coffee. In addition, the creamers have good physico-chemical stability during shelf life. The novel hydrocolloid texturizing/stabilizing system includes kappa-carrageenan in the range of 0.06 to 0.09 wt/wt %; iota-carrageenan in the range of 0.05 to 0.11 wt/wt %; and guar gum in the range of 0.1 to 0.4 wt/wt %. Use of hydrocolloids outside the above ranges result in gelation or phase separation (e.g. serum, creaming). Examples within and outside of the ranges are provided below.

In one embodiment of the present invention, the creamer comprises high oleic oils ranging from 10 to 16 wt/wt % of the creamer composition.

For the best mouthfeel, and physico-chemical properties as such and when added to hot coffee, the creamer composition comprises oil between about 10 and 16 wt/wt % of the creamer. Preferably, the oil comprises a vegetable oil selected from the group consisting of high oleic canola, high oleic soybean oil, high oleic sunflower, high oleic safflower or a combination thereof.

In one embodiment of the present invention, the creamer comprises caseinate salt ranging from 1.5 to 2.2 wt/wt % of the creamer.

In another embodiment of the present invention, the creamer comprises sugar comprising sucrose, lactose, glucose, fructose, sweetener and/or combinations or ranging from 0-40 wt/wt % of the creamer.

In another embodiment of the present invention, the creamer comprises a sweetener in an amount of about 0.0003 to about 10 wt/wt % of the creamer.

The term “sweetener” is another type of sugar that includes other plant derived nutritive and non-nutritive sweeteners, and chemically synthesized non-nutritive high intensity sweeteners.

Liquid Beverage Composition and Product

A beverage composition according to the invention comprises the creamer as described in the present invention and may be any beverage composition such as e.g. a beverage, e.g. a coffee beverage, a cocoa or chocolate beverage, a malted beverage, a fruit or juice beverage, a carbonated beverage, a soft drink, or a milk based beverage; a performance nutrition product, powder or ready-to-drink beverage; a medical nutrition product; a dairy product, e.g. a milk drink, a yogurt or other fermented dairy product; a product for improving mental performance or preventing mental decline, or a skin improving product.

Beverage or Beverage Composition

A beverage according to the invention comprises the creamer as described in the present invention and may e.g. be in the form of liquid or liquid concentrate to be mixed with a suitable liquid, e.g. water or milk, before consumption, or a ready-to-drink beverage. By a ready-to-drink beverage is meant a beverage in liquid form ready to be consumed without further addition of liquid. A beverage according to the invention may comprise any other suitable ingredients known in the art for producing a beverage, such as e.g. sweeteners, e.g. sugar, such as invert sugar, sucrose, fructose, glucose, or any mixture thereof, natural or artificial sweetener; aromas and flavours, e.g. fruit, cola, coffee, or tea aroma and/or flavour; fruit or vegetable juice or puree; milk; stabilizers; emulsifiers; natural or artificial colour; preservatives; antioxidants, e.g. ascorbic acid; and the like.

If the beverage is a liquid concentrate or a ready-to-use or drink beverage it may be subjected to a heat treatment to increase the shelf life or the product, e.g. by retorting, UHT (Ultra High Temperature) treatment, HTST (High Temperature Short Time) pasteurization, batch pasteurization, or hot fill.

According to a particular embodiment, the pH is controlled by the presence of a buffer. The buffer comprises disodium phosphate, di-potassium phosphate, sodium or potassium bicarbonate or combinations thereof.

The products may thus include a stabilizer system. A “stabilizer system” is to be understood as a mixture of ingredients which contributes to the stability of the beverage product with respect to shelf life, overall texture properties etc. Thus, the stabilizer system may comprise any ingredients which are of physical and functional importance to the beverage. The stabilizer system that may be used in the present products preferably comprises at least one emulsifier. In one embodiment the emulsifier is mixture of mono- and diglycerides in the range of 0.13 to 0.3 wt/wt % and tartaric acid esters of monoglycerides in the range of 0.4 to 0.8 wt/wt %.

According to another particular embodiment, the stabilizer system used in the products of the invention comprises at least one non-natural emulsifier. Any food grade emulsifier typically used in beverage could be used. Suitable emulsifiers include sugar esters, monoglycerides, diglycerides, esters of monoglycerides and diglycerides, lecithin, lysolecithin, polysorbates, sodium stearoyl lactylate and mixtures thereof.

The product may additionally comprise flavours or colorants. These are used in conventional amounts which can be optimized by routine testing for any particular product formulation.

### EXAMPLES

The present invention is illustrated further herein by the following non-limiting examples.

### Example 1

Liquid Creamers were Produced as Below.

A dry blend of guar, kappa- and iota-carrageenans with sucrose was prepared by mixing together 5000 g of sucrose with 300 g of guar, 90 g of kappa- and 80 g iota-carrageenans. The dry blend was added into 50 kg of hot water 70° C.) under high agitation. 400 g of di-potassium phosphate was then added to the tank under continuous agitation.

Next, a dry blend of other powder ingredients was prepared by mixing together 2000 g of sodium caseinate. The dry blend was added to the tank of hot water with above stabilizers under high agitation. After ˜10 minutes of mixing, emulsifiers (250 g of Dimodan and 750 g of Panodan) and 300 g of calcium lactate were added into the tank under continuous high agitation. Further, 16 kg of oil was added under high agitation, followed by 25 kg of sucrose. Additional water was added to adjust the total product amount to 100 kg.

The mixture was preheated and homogenized at 175/35 bar pressure 80° C.

The mixture was further heated and UHT treated for 5 sec at 143° C.

The mixture was cooled to 80° C. and homogenized at 175/35 bar at this temperature and further cooled below 20° C.

The liquid creamer was aseptically filled into bottles. The resultant liquid creamer can be aseptically filled in any aseptic containers such as, for example, jars, jugs or pouches. The liquid creamer was stored 1 month at 38° C., 3 months at 30° C. and 9 months at room and refrigeration temperatures.

The physico-chemical stability and sensory of creamer and coffee beverages with added liquid creamer were judged by trained panelists. No phase separation (creaming, de-oiling, marbling, etc.), gelation, and practically no viscosity changes were found during the storage.

It was surprisingly found that the liquid creamer has good appearance, mouth-feel, smooth Greek yogurt type texture and a good flavor without “off” taste. In addition, the creamer showed high whitening capacity when added to a coffee.

### Example 2

A dry blend of guar, kappa- and iota-carrageenans with sucrose was prepared by mixing together 5000 g of sucrose with 500 g of guar, 70 g of kappa- and 50 g iota-carrageenans. The dry blend was added into 50 kg of hot water (˜70° C.) under high agitation. 400 g of di-potassium phosphate was then added to the tank under continuous agitation.

Next, a dry blend of other powder ingredients was prepared by mixing together 2000 g of sodium caseinate. The dry blend was added to the tank of hot water with above stabilizers under high agitation. After ˜10 minutes of mixing, emulsifiers (250 g of Dimodan and 750 g of Panodan) and 300 g of calcium lactate were added into the tank under continuous high agitation. Further, 16 kg of oil was added under high agitation, followed by 25 kg of sucrose. Additional water was added to adjust the total product amount to 100 kg.

The mixture was preheated and homogenized at 175/35 bar pressure 80° C.

The mixture was further heated and UHT treated for 5 sec at 143° C.

The mixture was cooled to 80° C. and homogenized at 175/35 bar at this temperature and further cooled below 20° C.

The liquid creamer was aseptically filled into bottles. The resultant liquid creamer can be aseptically filled in any aseptic containers such as, for example, jars, jugs or pouches. The liquid creamer was stored 1 month at 38° C., 3 months at 30° C. and 9 months at room and refrigeration temperatures.

The physico-chemical stability and sensory of creamer and coffee beverages with added liquid creamer were judged by trained panelists. No phase separation (creaming, de-oiling, marbling, etc.), gelation, and practically no viscosity changes were found during the storage.

It was surprisingly found that the liquid creamer has good appearance, mouth-feel, smooth condensed milk concentrate texture and a good flavor without “off” taste. In addition, the creamer showed high whitening capacity when added to a coffee.

### Example 3

A liquid creamer was prepared as in Example 1 but using 130 g of iota-carrageenan. The physico-chemical stability and sensory of liquid creamer and coffee beverages with added liquid creamer were judged by trained panelists. A sensory evaluation showed severe gelation in the bottle.

### Example 4

A liquid creamer was prepared as in Example 1 but using 40 g of iota-carrageenan. The physico-chemical stability and sensory of liquid creamer and coffee beverages with added liquid creamer were judged by trained panelists. No yogurt texture was found by sensory evaluations.

### Example 5

A liquid creamer was prepared as in Example 1 but using 100 g of kappa-carrageenan. The physico-chemical stability and sensory of liquid creamer and coffee beverages with added liquid creamer were judged by trained panelists. A sensory evaluation showed severe gelling.

### Example 6

A liquid creamer was prepared as in Example 1 but using 50 g of kappa-carrageenan. The physico-chemical stability and sensory of liquid creamer and coffee beverages with added liquid creamer were judged by trained panelists. No yogurt texture was found by sensory evaluations.

### Example 7

A liquid creamer was prepared as in Example 2 but using 130 g of iota-carrageenan. The physico-chemical stability and sensory of liquid creamer and coffee beverages with added liquid creamer were judged by trained panelists. A sensory evaluation showed severe gelation in the bottle.

### Example 8

A liquid creamer was prepared as in Example 2 but using 40 g of iota-carrageenan. The physico-chemical stability and sensory of liquid creamer and coffee beverages with added liquid creamer were judged by trained panelists. Phase separation was found by sensory evaluations.

### Example 9

A liquid creamer was prepared as in Example 2 but using 100 g of kappa-carrageenan. The physico-chemical stability and sensory of liquid creamer and coffee beverages with added liquid creamer were judged by trained panelists. A sensory evaluation showed severe gelling.

### Example 10

A liquid creamer was prepared as in Example 2 but using 50 g of kappa-carrageenan. The physico-chemical stability and sensory of liquid creamer and coffee beverages with added liquid creamer were judged by trained panelists. Phase separation was found by sensory evaluations.

### Example 11

A liquid creamer was prepared as in Example 1 but using 400 g of calcium lactate. The physico-chemical stability and sensory of liquid creamer and coffee beverages with added liquid creamer were judged by trained panelists. A sensory evaluation showed severe gelation in the bottle.

### Example 12

A liquid creamer was prepared as in Example 1 but using 50 g of iota-carrageenan. The physico-chemical stability and sensory of liquid creamer and coffee beverages with added liquid creamer were judged by trained panelists. No yogurt texture was found by sensory evaluations.

1. A liquid non-dairy creamer composition comprising:
oil in the range of 10-16 wt/wt %;
caseinate salts in the range of 1.5 to 2.2 wt/wt %;
mono-/diglycerides in the range of 0.13 to 0.3 wt/wt %;
tartaric acid esters of monoglycerides in the range of 0.4 to 0.8 wt/wt %;
kappa-carrageenan in the range of 0.06 to 0.09 wt/wt %;
iota-carrageenan in the range of 0.05 to 0.11 wt/wt %; and
guar gum in the range of 0.1 to 0.4 wt/wt %.

2. The creamer of claim 1 is Extended Shelf-Life (ESL) or aseptic shelf-stable liquid creamers with sweetened condensed milk-like texture.

3. The creamer of claim 1 is ESL or aseptic shelf-stable liquid creamers with yogurt-like texture.

4. The creamer of claim 3, further comprises a calcium lactate in the range of 0.1 to 0.3 wt/wt %.

5. The creamer of claim 1, wherein the oil is high oleic oils comprising a vegetable oil selected from the group consisting of high oleic canola, high oleic soybean oil, high oleic sunflower, high oleic safflower and combinations thereof.

6. The creamer of claim 1, wherein caseinate salts is selected from the group consisting of sodium caseinate, calcium caseinate and combinations thereof.

7. The creamer of claim 1, further comprises sugar selected from the group consisting of sucrose, lactose, glucose, fructose, sweetener and combinations ranging from 0 to 40 wt/wt % of the creamer.

8. The creamer of claim 1 further includes a buffer selected from the group consisting of dipotassium phosphate, potassium citrate, sodium citrate, sodium bicarbonate or combination thereof

9. A beverage comprising the creamer according to claim 1.

10. The beverage of claim 9 is a coffee, tea, or chocolate.

11. A process of preparing the creamer of claim 1 comprising:
dissolving caseinate salts, mono-/diglycerides, tartaric acid esters of monoglycerides, kappa-carrageenan, iota-carrageenan, and guar gum in hot water under high shear mixing;
(ii) adding oil to the mixture of step (i) under high shear mixing;
(iii) homogenizing the composition at temperature ranging from 70-85° C.;
(iv) sterilizing the composition using ultra-high temperature (UHT) treatment at 138-147° C.;
(v) homogenizing the composition at temperature ranging from 70-85° C.;
and
(vi) cooling and filing the creamer under aseptic conditions.
